(19) United States
(12) Patent Application Publication
(10) Pub. No.: US 2008/0016734 A1
(43) Pub. Date: Jan. 24, 2008

(54) Illuminated sign and method of making

(75) Inventor: Ismael Basha, Troy, MI (US)

Correspondence Address: HARNESS, DICKEY & PIERCE, P.L.C., P.O. BOX 828, BLOOMFIELD HILLS, MI, 48303, US

(73) Assignee: TSS, Inc.

(21) Appl. No.: 11/488,818

(22) Filed: Jul. 18, 2006

(51) Int. Cl. G09F 13/00

(52) U.S. Cl. 40/552

(57) ABSTRACT

An illuminated sign and method of making includes a series of characters formed of solid, substantially transparent material. The series of characters may collectively define a footprint and a first thickness. A sheet of material, formed separately from the series of characters, defines a base and a second thickness. The base defines a series of openings formed therein and collectively defines a shape suitable to accept the footprint defined by the letters in an assembled position. A housing retains the base and has a light source therein. The light source may be adapted to direct light through the base and the series of characters.

### FIELD

This invention relates generally to illuminated signs and, more particularly, to a method and apparatus for making an illuminated sign.

### BACKGROUND

Illuminated signs may be used in many applications to enhance a particular portion of the sign or to improve the visual presentation of the sign as a whole. For example, many businesses utilize various display signs to draw the attention of a perspective customer. One common strategy is to adapt various lighting configurations within the sign. For example, some signs have displays that illuminate and/or flash.

In some applications however it may be more challenging to adapt an illuminated sign for use in an unfavorable environment. For example, in wet or damp environments such as in and around a car wash, the environment may be particularly harmful to electronics such as lighting. In this way, over time such illuminated displays may become corroded and in some cases inoperable. It would be desirable to provide an illuminated sign that is cost effective to manufacture and provides improved visual stimulation.

### SUMMARY

An illuminated sign includes a series of characters formed of solid, substantially transparent material. The series of characters may collectively define a footprint and a first thickness. A sheet of material, formed separately from the series of characters, defines a base and a second thickness. The base defines a series of openings formed therein and collectively defines a shape suitable to accept the footprint defined by the letters in an assembled position. A housing retains the base and has a light source therein. The light source may be adapted to direct light through the base and the series of characters.

According to other features, the first thickness of the series of characters is greater than the second thickness of the base such that the series of characters extend beyond a front face of the base in the assembled position. An adhesive may be disposed between each of the series of characters and the series of openings. The adhesive may retain the characters in a nested position in the openings. In one example, the adhesive may be disposed around a perimeter of each of the series of characters.

A semi-transparent film may be disposed around a surface of each of the series of characters. A backing material may be disposed on a rear side of the base. The backing material may border each of the series of characters and the base. The base and the characters may be formed of plastic. In one example, the backing material may include a graphic thereon. A landing area may be defined on the backing material. The landing area is adapted to align with the footprint of the series of characters.

A method of making an illuminated sign includes forming a series of characters from a solid block of substantially transparent material. A series of openings may be formed in a sheet of material. The sheet of material defines a base. The series of openings substantially correspond to a footprint of a series of characters. Each of the series of letters are securably located into the respective series of openings to a secure position. The base may be coupled to the housing, the housing having a light source therein.

According to additional features, heat may be applied to a perimeter of each of the series of characters, the heat increasing transparency at the perimeter of each of the series of characters. A semi-transparent film may be applied across a surface of each of the series of characters. An adhesive may be applied around at least one of a surface defining a perimeter of the series of characters and a surface defining the series of openings.

Further areas of applicability of the present disclosure will become apparent from the detailed description provided hereinafter. It should be understood that the detailed description and various examples, while indicating various embodiments of the invention, are intended for purposes of illustration only and are not intended to limit the scope of the following claims.

### BRIEF DESCRIPTION OF THE FIGURES

The present invention will become more fully understood from the detailed description and the accompanying drawings, wherein:

FIG. 1 is a perspective view of a sign assembly according to the present teachings;

FIG. 2 is a perspective view of a sheet of material from which openings are formed to accept the letters;

FIG. 3 is a perspective view of a block of material from which letters are formed according to according to the present teachings;

FIG. 4 is a perspective view of a letter of FIG. 1 subject to a heat treatment according to the present teachings;

FIG. 5 is a perspective view of a layer of semi-transparent film disposed about a surface of the letter of FIG. 2;

FIG. 6 is an exploded view of the letters, the semi-transparent film, the sheet of material and a backing material;

FIG. 7 is a sectional view of the sign assembly taken along line 7-7 of FIG. 1;

FIG. 8 is a perspective view of a housing including an exemplary light source, the housing adapted to securably mount the sheet of material in an assembled position; and

FIG. 9 is a perspective view of a sign assembly according to additional features of the present invention.

### DETAILED DESCRIPTION OF VARIOUS EMBODIMENTS

The following description of various embodiment(s) is merely exemplary in nature and is in no way intended to limit the application or uses.

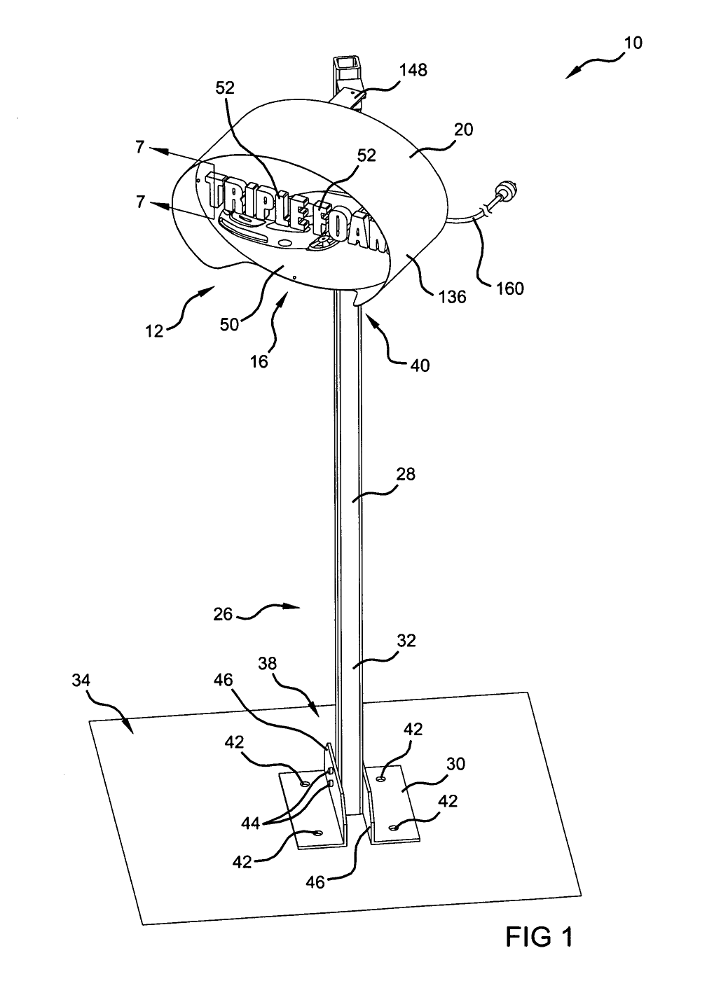

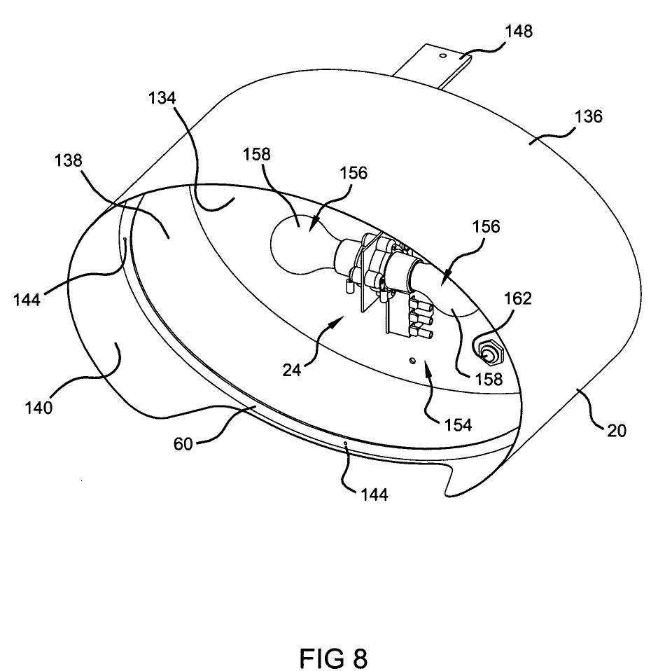

With initial reference to FIG. 1, an illuminated sign assembly according to the present teachings is shown and generally identified at reference numeral 10. The sign assembly 10 generally includes a display portion 12 disposed on a front portion 16 of a housing 20. As will be described in greater detail herein, the housing 20 may include a light source 24 (FIG. 8) for directing light at the display portion 12. The light directed at the display portion 12 illuminates the display portion 12.

The illuminated sign assembly 10 may also include a support frame 26 adapted to locate the housing 20 and display portion 12 in a desired mounted position. As will become appreciated throughout the present disclosure, the sign assembly 10 may be particularly useful in the car wash industry. The durable configuration of the sign assembly as a whole and specifically the housing 20, the display portion 12 and the light source 24 is suitable for use in less than desirable environments such as in and around car washes. Such environments may have high levels of moisture, humidity, salt, dirt, and other elements generally undesirable for an electric component. Those skilled in the art will appreciate however, that the sign assembly 10 in not limited to application in the car wash assembly. In this regard, the sign assembly 10 may be used in other applications and environments.

In the exemplary sign assembly 10 shown in FIG. 1, the support frame 26 generally includes a post 28 and a lateral brace 30. In the example shown, the post 28 comprises a longitudinal member 32 for presenting the housing 20 and display portion 12 at a vertical offset relative to a mounting surface 34. The longitudinal member 32 generally defines a first end 38 selectively secured to the lateral brace 30 and a second end 40 selectively secured to the housing 20. The lateral brace 30 may define a plurality of passages 42 for accepting fasteners (not shown) adapted to securely locate the lateral brace 30 relative to the mounting surface 34. In one example, the lateral brace 30 may accept fasteners 44 through a pair of opposing transverse flanges 46 for securably locating through passages (not specifically shown) in the first end 38 of the longitudinal member 32. It is appreciated that the lateral brace 30 may comprise other configurations. For example, the longitudinal member 32 may extend horizontally between the housing 20 and the lateral brace 30. Alternatively, the longitudinal member 32 may comprise a planar member. In another example, the lateral brace 30 may be omitted entirely and the housing 20 directly mounted to a mounting surface. Such a configuration may be desirable for mounting to a pre-existing structure such as a wall, door, machine or other surface. Other configurations are contemplated.

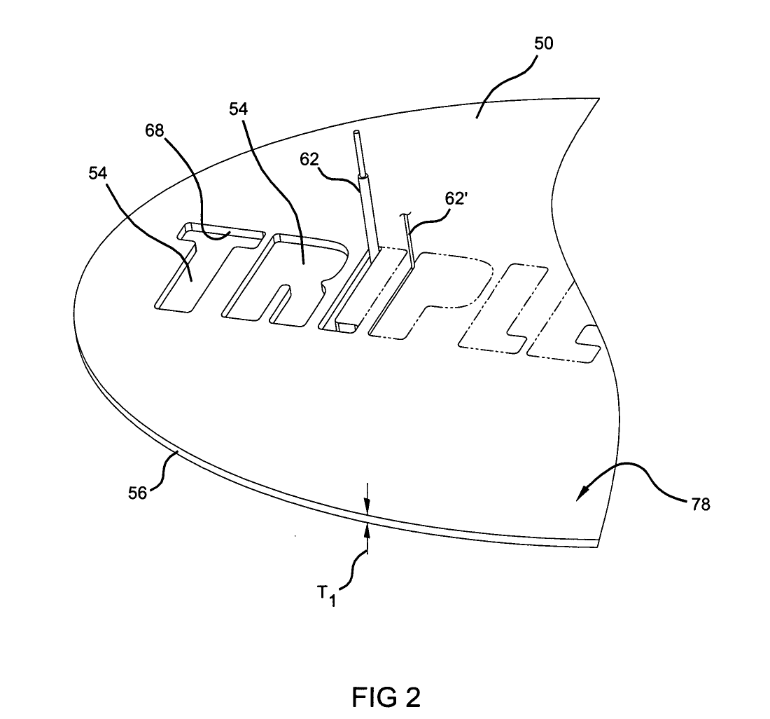

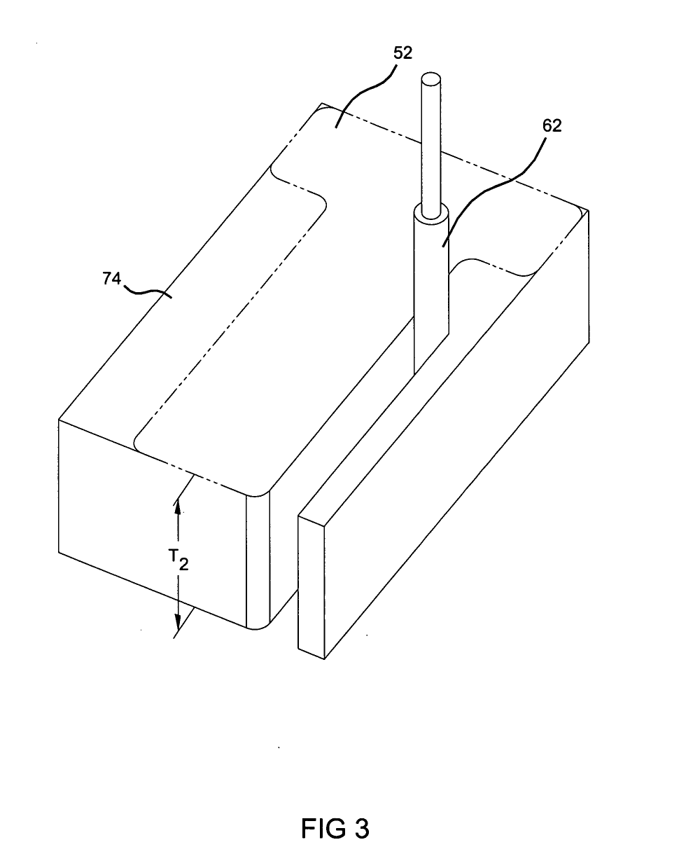

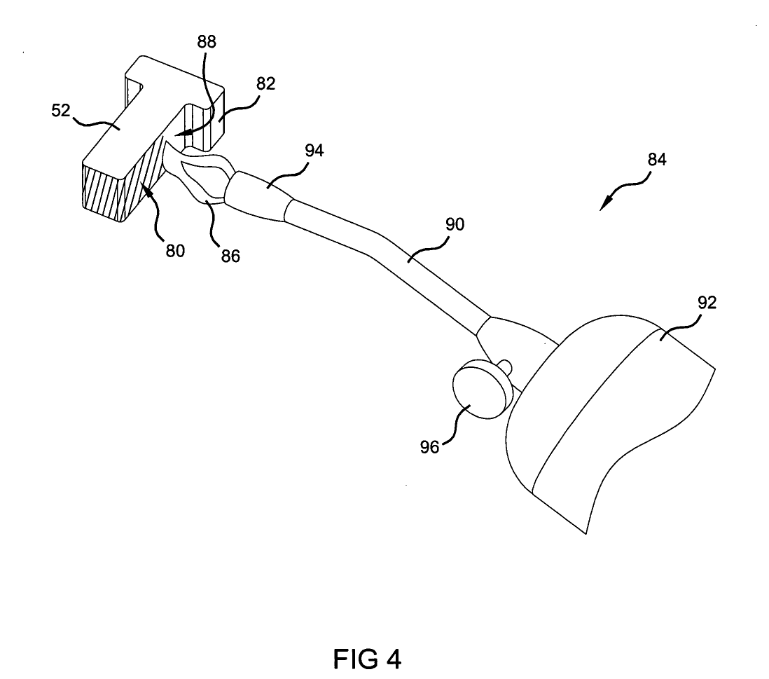

With continued reference to FIG. 1 and further reference to FIGS. 2-4, the display portion 12 will be described in greater detail. The display portion 12 generally includes a base 50 (FIG. 2) supporting a plurality of letters or characters 52 (FIG. 3). The base 50 may define a thickness T₁. In one example, a plurality of openings 54 may be formed through the entire thickness of the base 50. In another example, the plurality of openings 54 may be defined through a partial thickness of the base 50. The base 50 may be formed of a solid transparent material such as plastic for example. In the example shown, the characters 52 are in the form of letters. In one example, the base 50 may define a perimeter 56 suitable to be accepted by the housing 20 at an annular flange 60 (FIG. 8).

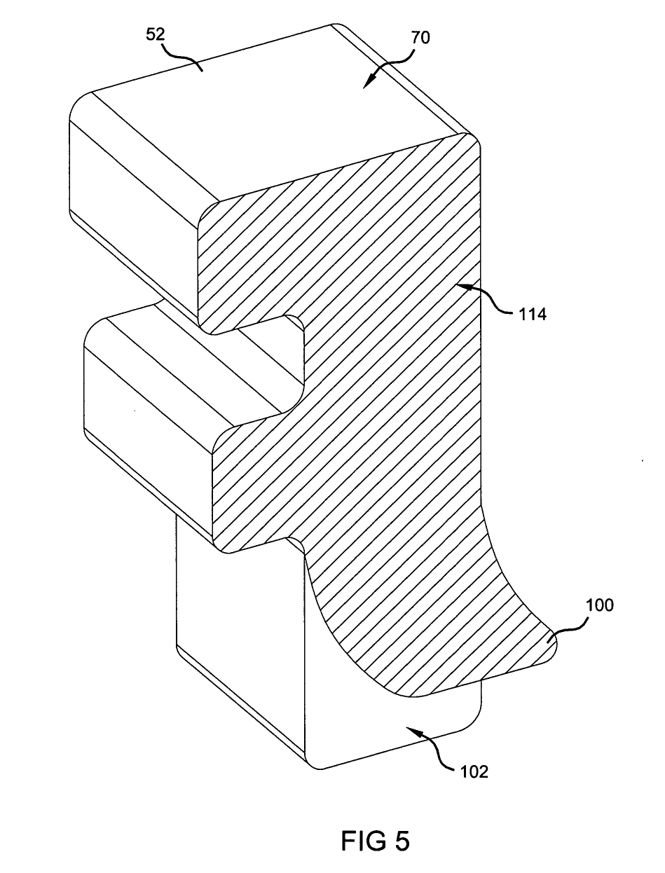

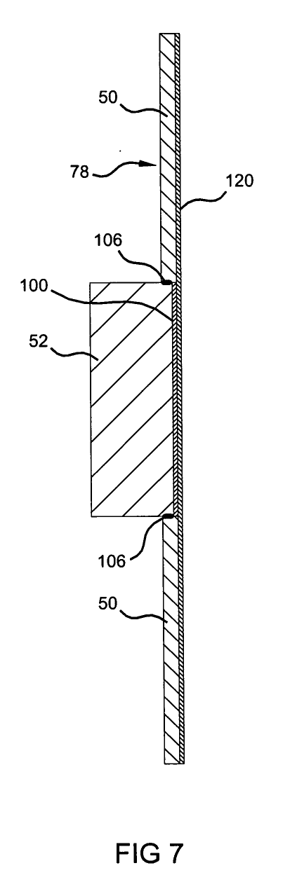

An exemplary method of forming the base 50 will now be described. The base 50 may be cut from a blank of material into a desired shape such as one conforming to the outer perimeter 56. The plurality of openings 54 conforming to the respective plurality of characters 52 may be cut into the base 50 with a cutting tool 62. As explained above, the plurality of openings 54 may pass entirely through the thickness of the base 50. As can be appreciated, an outer dimension defined by an inner sidewall 68 of each opening 54 may be slightly larger than an outer dimension defined by an outer sidewall 70 (FIG. 5) of the respective characters 52 such that the characters 52 can nest into the respective openings 54 in an assembled position as best shown in FIG. 7. In one example, the base 50 may be formed utilizing a computer numerical control (CNC) cutting device. It is contemplated that the base 50 may be formed using other methods such as molding the base in a single step. Other methods may be employed. For example, a laser 62′ may be used to cut the openings 54.

Referring now specifically to FIGS. 3-6, the characters 52 and a method of forming the characters 52 will be described according to various embodiments. The characters 52 may be formed of a solid transparent material such as plastic. The characters 52 may each be cut from a blank of material 74 into the desired shape. The characters 52 may define a thickness T₂. The thickness T₂ may be greater than the thickness T₁ such that the characters 52 extend beyond a front surface 78 of the base 50 in an assembled position (see e.g. FIGS. 1, 6 and 7). As described above, the characters 52 may define an outer dimension defined by an outer sidewall 70 slightly less than the outer dimension 68 of the respective openings 54 such that the characters 52 may be accommodated in the respective openings 54.

In some instances, once the characters 52 are formed, they may have an opaque or slightly cloudy surface 80 on an outer perimeter 82. Such a condition may be caused by the cutting tool 62 during formation of the characters 52. A heat source 84 may be used to apply heat to the perimeter 82. Application of heat such as by flame 86 may reduce the distortion on the cloudy surface 80 and turn the cloudy surface 80 into a clearer, more transparent surface 88. In one example, a hand held torch comprising a fuel tank 92, nozzle 94 and adjuster knob 96 may be used to apply heat to the characters 52. It is appreciated that other methods may be employed to increase the transparency of the characters 52. According to another example, the characters 52 may be formed by laser (see e.g. laser 62′, FIG. 2). When formed by laser, the characters 52 may present a clear outer surface 88 without the need to apply a heat source 84 such as flame 86 to enhance clarity.

Next, according to one example as shown in FIG. 5, a semi-transparent film 100 may be disposed across a rear face 102 of each of the characters 52. The semi-transparent film 100 may define a color for enhanced visual effect. The semi-transparent film 100 may be disposed across the rear face 102 by a self contained adhesive provided on the film 100 or by way of supplemental adhesive.

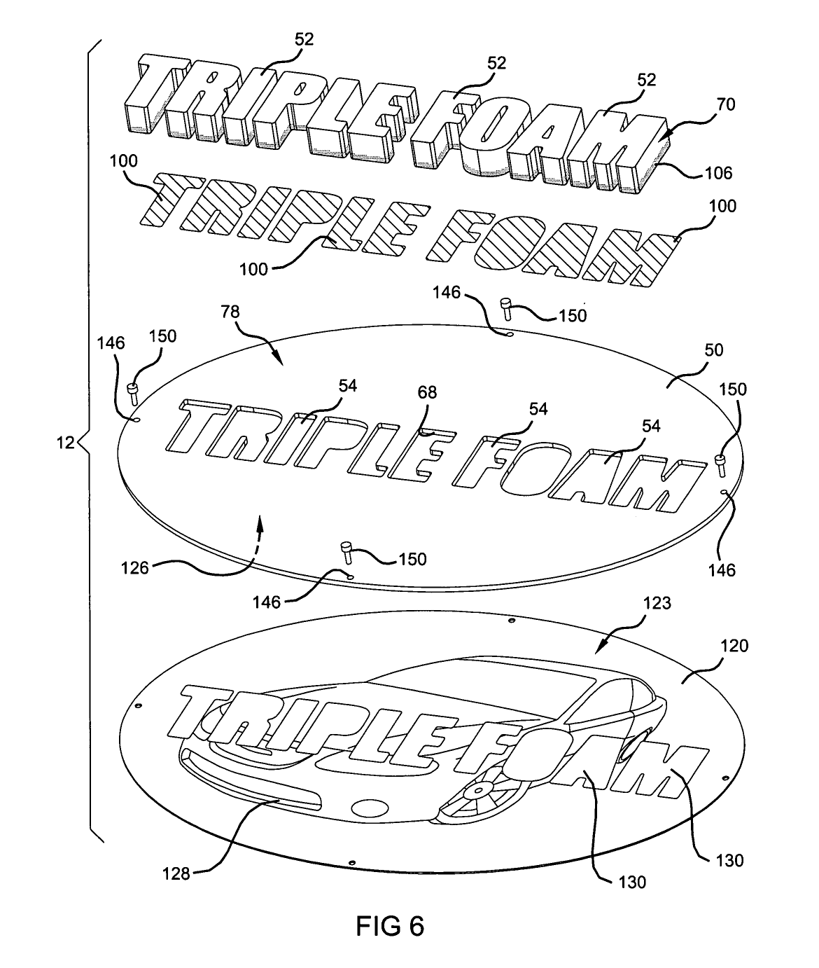

According to one example as shown in FIG. 6, an adhesive 106 may be applied to the outer perimeter of each character 52. As can be appreciated, the adhesive 106 is adapted to form a bond between the characters 52 and the respective inner sidewalls 68 of the openings 54 in the base 50. While the adhesive 106 is shown specifically applied to outer sidewall 70 of each character 52, adhesive may alternatively or additionally applied to the rear surface 114 of the characters 52 such as across the semi-transparent film 100.

With continued reference to FIG. 6, a backing material 120 having a graphic 122 is shown. The backing material 120 may comprise a semi-transparent film. In one example, the backing material 120 may be disposed across the rear face 126 of the base 50 by a self contained adhesive provided on the backing material 120 or by way of supplemental adhesive. The graphic 122 may define any printed graphic such as a vehicle or other display. The graphic 122 may further define a printed area 128 having complementary landing area 130 corresponding to the footprints of the respective characters 52. The printed area 128 and the landing area 130 are defined along a continuous, unitary sheet. Because the landing area 130 is absent any graphic, light may pass substantially uninterrupted through the landing area 130 of the backing material 120. In addition, because the backing material 120 is a unitary piece across the entire surface of the base 50, the backing material 120 may provide additional support to the characters 52 to inhibit movement of the characters 52 relative to the base 50 in the assembled position. Furthermore, the backing material 120 helps inhibit moisture and other debris from entering the housing 20 through the display portion 12.

With reference now to FIG. 8, the housing 20 and light source 24 will be described in grater detail. The housing 20 may be formed of a corrosive resistant material such as, but not limited to, stainless steel or aluminum. The housing 20 may generally define a rear surface 134 and an outer surface 136. In the example shown, the outer surface 136 generally defines an annular wall extending generally transverse to the rear surface 134. The annular flange 60 may be formed around an inner wall 138 of the outer surface 136 for accepting the display portion 12 thereon. The outer surface 136 may also define an outward flange portion 140 outboard of the annular flange 60. The outward flange portion 140 may be adapted to shield external light, water or other elements from the display portion 12. Further, the flange portion 140 may generally direct light from the light source 24 outwardly in a direction transverse to a plane of the base 50. Bores 144 may be formed through the annular flange 60 for aligning with complementary bores 146 formed through the base 50. Fasteners 150 may be passed through the respective bores 144 and 146 for locating the display portion 12 in a secure position relative to the housing 20.

A bracket 148 may extend from the housing 20 for mating with the second end 40 of the longitudinal member 32. The light source 24 may include electronic circuitry 154 and a light emitting device 156. In the example shown, the light emitting device 156 may comprise a conventional light bulb 158. It is appreciated that the light source 24 may comprise any light emitting device 156. For example, the light source 24 may comprise various ballasts for cooperating with various light emitting devices. By way of example, fluorescent tubing such as normal output or very high output (VHO) fluorescent tubing, metal halide bulbs, light emitting diodes (LED's), halogen bulbs and others are contemplated by the present teachings. An electrical cord 160 (FIG. 1) may pass through a passageway 162 formed in the housing.

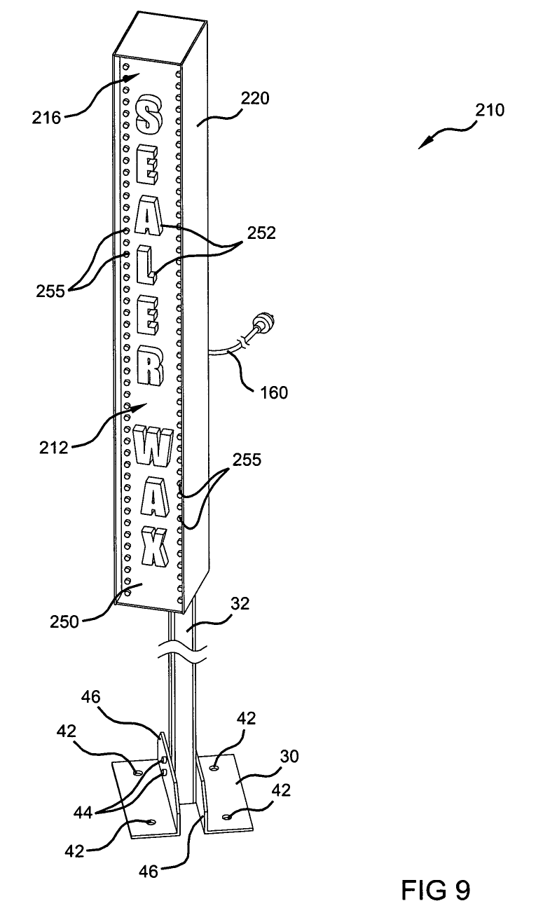

Turning now to FIG. 9, a sign assembly according to another embodiment is illustrated and generally referred to at reference 210. For clarity, like reference numerals have been used to designate like components. The sign assembly 210 generally includes a display portion 212 disposed on a front portion 216 of a housing 220. As shown, the housing 220 of the sign assembly 210 is generally longitudinal and adapted to display characters 252 in a vertical orientation. A plurality of LED's 255 may be disposed across a face 278 of the display portion 212. In one example, the display portion 212 may be configured similar to the display portion 12 of the sign assembly 10. In another example, instead of a transparent base 50, the base 250 may be solid such as formed of metallic material. The base 250 may define openings for accepting the characters 252 but may be adapted to block light passage. As a result, only the characters 252 and the LED's 255 are viewed as illuminated. The light source may be any suitable light source such as described above. As can be appreciated, a longitudinal configured bulb may be particularly useful.

According to one advantage of the present teachings, the characters 52 may define a distinct color from the backing material 120 to enhance visual appearance. Furthermore, because the graphic 122 provides a landing area 130, the characters 52 receive substantially uninterrupted light from the light source 24.

Those skilled in the art can now appreciate from the foregoing description that the broad teachings of the present invention can be implemented in a variety of forms. Therefore, while this invention has been described in connection with particular examples thereof, the true scope of the invention should not be so limited since other modifications will become apparent to the skilled practitioner upon a study of the drawings, the specification and the following claims.

What is claimed is:

1. An illuminated sign comprising:
a series of characters formed of solid, substantially transparent material, the series of characters collectively defining a footprint and a first thickness;
a sheet of material separately formed from the series of characters, the sheet of material defining a base, the base having a second thickness and defining a series of openings formed therein, wherein the series of openings collectively define a shape suitable to accept the footprint defined by the characters in an assembled position; and
a housing retaining the base and having a light source therein, the light source adapted to direct light through the base and the series of characters.

2. The illuminated sign of claim 1 wherein the first thickness of the series of characters is greater than the second thickness of the base such that the series of characters extend beyond a front face of the base in the assembled position.

3. The illuminated sign of claim 2 wherein an adhesive is disposed between each of the series of characters and the series of openings, the adhesive retaining the characters in a nested position in the openings.

4. The illuminated sign of claim 3 wherein the adhesive is disposed around a perimeter of each of the series of characters.

5. The illuminated sign of claim 4, further comprising a semi-transparent film disposed about a surface of each of the series of characters.

6. The illuminated sign of claim 5, further comprising a backing material disposed on a rear side of the base, the backing material bordering each of the series of characters and the base.

7. The illuminated sign of claim 6 wherein the series of characters are formed of plastic.

8. The illuminated sign of claim 7 wherein the base is formed of plastic.

9. The illuminated sign of claim 6 wherein the backing material is adapted to pass light therethrough and includes a graphic displayed thereon.

10. The illuminated sign of claim 9 wherein the backing material includes a landing area adapted to align with the footprint of the series of characters, wherein the landing area defines a surface absent the graphic.

11. The illuminated sign of claim 10 wherein the semi-transparent film is a distinct color from the graphic.

12. The illuminated sign of claim 7 wherein the series of characters are arranged vertically and wherein the housing defines a generally upright vertical rectangular housing.

13. The illuminated sign of claim 12, further comprising a series of light emitting diodes (LED's) arranged adjacent the series of characters.

14. An illuminated sign comprising:
a series of block characters formed of transparent material and each having a front face and a rear face, the series of block characters defining a collective first thickness;
a layer of semi-transparent film disposed across the rear face of the series of block characters;
a sheet of material defining a base and having a front surface and a rear surface defining a second thickness greater than the first thickness, the base defining a series of openings;
wherein the series of block characters are received in the series of openings such that the rear faces of the block characters are substantially coplanar to the rear surface of the base; and
a housing retaining the base and having a light source therein, the light source adapted to direct light through the base and the series of characters.

15. The illuminated sign of claim 14, further comprising a semi-transparent backing material disposed on the rear surface of the base, the backing material having a graphic displayed thereon.

16. A method of making an illuminated sign comprising:
forming a series of characters from a solid block of substantially transparent material, the series of characters collectively defining a footprint;
forming a series of openings in a sheet of material, the sheet of material defining a base, the series of openings substantially corresponding to the footprint of the series of characters;
securably locating each of the series of characters into the respective series of openings to a secure position; and
coupling the base to a housing, the housing having a light source therein.

17. The method of claim 16, further comprising:
applying heat onto a perimeter of each of the series of characters, the heat increasing transparency at the perimeter of each of the series of characters.

18. The method of claim 17, further comprising:
applying a semi-transparent film across a surface of each of the series of characters.

19. The method of claim 18, further comprising:
applying an adhesive around at least one of a perimeter of the series of characters and a surface defining the series of openings.

20. The method of claim 19, further comprising:
applying a backing material onto a rear face of the base, the backing material defining a graphic and a landing area, the landing area adapted to align with the footprint of the series of characters.
